(19) United States
(12) Patent Application Publication
(10) Pub. No.: US 2004/0036041 A1
(43) Pub. Date: Feb. 26, 2004

(54) Device for assembling components on a substrate

(76) Inventor: Michael Hoehn, Obermaiselstein (DE)

Correspondence Address: KENYON & KENYON, ONE BROADWAY, NEW YORK, NY, 10004, US

(21) Appl. No.: 10/344,435

(22) PCT Filed: May 22, 2002
(86) PCT No.: PCT/DE02/01840

(30) Foreign Application Priority Data
Jun. 11, 2001 (DE) 101 28 111.0

(51) Int. Cl. G01V 8/00; G01N 21/86

(52) U.S. Cl. 250/559.3

(57) ABSTRACT

A device for assembly of components, in particular semiconductor chips, on a substrate having a first traversing unit for picking up the component together with a component holder at a first location and setting down the component at a second location on the substrate is described, a position measuring unit for optically determining an actual position of the component as a function of an actual position of the substrate being situated on an optical traversing unit for traversing the position measuring unit from a working position in the area of the substrate to a resting position; this permits fully automatic assembly of a wide variety of components on substrates and at the same time has a high throughput in interlinked production and a very high positioning precision. This is achieved by the fact that the substrate is situated on a conveyance device for largely continuous supply and removal of numerous substrates to and from the device.

### FIELD OF THE INVENTION

The present invention relates to a device for assembly of components.

### BACKGROUND INFORMATION

Increasing miniaturization and integration of functions in electronic modules and microsystems require that automatic assembly systems be used for rapid and precise alignment of semiconductor chips with respect to a circuit board or substrate. In most cases, precision automatic pick-and-place systems based on a Cartesian system are used, picking up a chip with the help of a gripper from a chip carrier (cut wafer, magazine, . . . ) at a first location and setting it down at its laterally offset assembly site on the substrate.

In the case of highly integrated surface-mount technologies such as the flip-chip technology in particular, a very high assembly precision of a few micrometers must be achieved. In flip-chip assembly, semiconductor chips must be positioned on the substrate with their structured side facing down and integrally joined there by soldering or gluing. To maintain the narrow assembly tolerances allowed, the facing structures on the underside of the component and the landing area of the substrate are recognized and adjusted by image processing with the known methods. Thus, positional inaccuracies such as those which occur due to inaccurate presentation or tolerances in the workpieces may be compensated.

Assembly devices of the type characterized above are known as die bonders. Images of the chip and the assembly position on the substrate recorded at separate locations are characteristic of these systems. The chip is gripped first and photographed by a first stationary camera situated in the working space and aimed upward, and an image of the underside of the chip is recorded. Then the assembly head moves over the substrate and locates the assembly site on the substrate by a second camera entrained laterally on the assembly head. With a known position of the two image recording locations, thee position of the chip and/or the substrate determined in the particular field of vision of the camera is transformed into the machine coordinate system, and the misalignment between the chip and substrate is calculated in axial coordinates. Then it is possible to determine a correction value, which is taken into account in the subsequent positioning. Because of the long traversing distances between the locally separate images recorded, however, this method is associated with positioning inaccuracies due to unavoidable deviations in the axial system, e.g., angle errors in the guides, division errors or measurement errors in the displacement measuring system, or inaccuracies in the spindle pitch of a spindle drive. To minimize the effects of such errors, a complex and cost-intensive mechanical system having a high absolute positioning precision of the axes is necessary. Die bonders currently available on the market generally achieve a precision between 20 μm and 60 μm.

On Dec. 8, 1992, another fully automatic assembly device designed specifically for flip-chip assembly was presented in a lecture titled “Equipment for Flip-Chip Bonding” at the “Flip-Chip Technology” seminar held by the VDI/VDE Technology Center Information Technology GmbH of Berlin at the Technical University of Dresden; this device is distributed today by the company Karl Suss in Garching. This assembly device uses a split-field optical system for optical position recognition of chip and substrate. The optical system is inserted into a measurement position between the substrate on an xy table and the chip which is held by the bonding head at a certain distance above the substrate. In this measurement position, the opposed structures of the chip and the substrate are projected into one optical beam path via a semitransparent mirror and multiple deflecting mirrors to display the superimposed image by using a video camera. Then by image processing, it is possible to determine the deviation of the chip relative to the substrate and correct it through the axes of the xy table. After aligning the chip with respect to the substrate structures, the position of the chip and substrate may be measured again using the optical system and readjusted, if necessary, until the deviation between the two actual positions has reached a defined allowed tolerance.

In this method, much smaller lateral position movements are necessary than those with the die bonders described above to compensate for the actual positions after the optical position measurement, so a higher assembly precision of less than 5 μm may be achieved. However, a precision adjustment via the rigid and relatively heavy axes of the xy table is relatively time consuming because of the unfavorable ratio of the high moving mass to the drive power.

To set down the chip, which is held above the optical system by the bonding head, the optical system is moved out of the path between the two workpieces and into a resting position at the side outside the region of the substrate, and the bonding head executes the set-down movement in the z coordinate.

Since the bonding head is only movable in the z direction, and the split-field optical system is movable only between two end positions (measurement position and resting position), an additional complex handling and loading device is necessary to bring the workpieces to be joined (substrates and chips) into the bonding area, i.e., the visible area of the optical system. To do so, a carousel head or a revolver head movable in the xy plane removes one substrate and one chip from a substrate magazine and chip magazine, respectively, and transfers them to the xy table and the bonding head, respectively. The corresponding magazines must be replaced and/or refilled manually as needed.

The machine configuration described above allows primarily handling of individual substrates with the revolver head, while processing of multiple usage [devices] or multiple workpiece carriers to increase productivity does not seem possible. Because of the discontinuous manual charging of the machine, interlinking with other manufacturing equipment in a production line having a directed continuous flow of material is impossible for reasons of productivity and lot tracking (traceability, known good die). Disadvantages thus include the comparatively low throughput rate of the device of approximately 200 to 300 components per hour, the high structural complexity for material handling within the machine and the relatively high cost associated with this as well as the high degree of specialization exclusively for assembly of flip-chips. In addition, a high complexity is necessary for image processing, because due to the use of the optical system described above, the structures of the chip and substrate are superimposed in a common image and thus must be selected and differentiated by the image analysis software.

Additional optical principles capable of simultaneously imaging the actual position of the component and the actual position of the substrate are described in the published U.S. Pat. No. 4,608,494 and U.S. Pat. No. 5,752,446. U.S. Pat. No. 5,457,538 and German Patent No. 195 24 475 also describe manual and semiautomatic positioning equipment using a beam-splitter optical system for position recognition. However, these are special laboratory devices which do not meet the requirements of fully automatic mass production with respect to their limited productivity.

### SUMMARY OF THE INVENTION

An object of the present invention is to provide a device for assembly of components, in particular semiconductor chips, permitting filly automatic assembly of a wide variety of different components on substrates and at the same time having a high throughput in an interlinked manufacturing process and a very high positioning precision.

Accordingly, a device according to the present invention is characterized in that the substrate is situated on a conveyance device for largely continuous supply and removal of numerous substrates to and from the device.

With the help of the conveyance device according to the present invention, in particular a comparatively high throughput of substrates and/or components in a production line is achieved with a high precision. For example, the conveyance device according to the present invention is designed as a transfer belt or the like and is integrated into an automatic production line together with other different production installations and/or systems for semiconductor components and/or is interlinked with them.

In an advantageous manner, a buffer segment for adapting the transport rate of the conveyance device with the transport rate(s) of an automatic production line is provided upstream and/or downstream from the conveyance device according to the present invention. In particular with the help of these buffer segments, the transport rate of the substrate in the device according to the present invention may be adapted to the rate of assembly of the component on the substrate. The transport rate of the substrate is preferably almost zero, at least at the moment of positioning or joining, so that the precision in positioning and/or assembly is improved.

The transport rate of the substrate on the conveyance device outside the positioning period of time is preferably at least temporarily significantly above the transport rate of the automatic production line, so that stoppage of the substrate and/or the conveyance device, if necessary, during positioning and/or assembly is implementable without sacrifices with regard to throughput rate and/or continuous supply and removal of the numerous substrates to and from the device according to the present invention.

The position measuring unit advantageously includes at least one optical device having two opposite directions of measurement for determining the two actual positions. In an advantageous manner, the optical device is combined with the conveyance device. This optical device includes a diametrically imaging optical head having two opposite directions of measurement for simultaneous image pickup of the actual positions of the substrate supplied on the conveyance device and the component and/or chip held above the substrate by a gripper and/or an assembly head. To obtain separate images that are relatively easily analyzed by digital image processing, for example, the structures of the chip and the substrate are imaged in each case on one camera in the optical head via a deflecting prism. The two cameras are situated horizontally behind the deflecting prism to achieve a short beam path. Because of the short beam path in particular, a high numeric aperture and thus a relatively high optical resolution may be achieved with a comparatively compact and lightweight design of the optical system. Such a compact optical system may be moved comparatively rapidly into and out of the area between the substrate and the component because of their relatively low mass to be accelerated, so the cycle time for assembly of components may be minimized to a great extent by using the device according to the present invention.

An optical unit according to Japanese Patent 32 17 095 and/or the as yet unpublished German Patent Application 100 12 043 A1 may preferably be used, these being characterized in particular by the features described above and thus by their relatively compact design and low mass to be moved.

A relative positioning principle is preferably implemented by the position measuring unit and/or optical unit, so that, for example, it is possible to use a first traversing unit and/or a handling system which traverses comparatively rapidly and possibly imprecisely from the first location to the area of the substrate over a relatively great distance. Accordingly, multiposition-capable assembly devices, e.g., pick-and-place devices, for example, having a standing and/or suspended axial portal system may be used as the first traversing unit. Such assembly devices have a comparatively large usable working space; for example, a component may be picked up at any location in the working space and positioned at any location above the substrate comparatively rapidly and possibly imprecisely by the first traversing unit. The actual position of the component relative to the actual position of the substrate and/or the assembly site is determined accurately by the optical device in an advantageous manner.

In a special refinement of the present invention, the conveyance device includes at least one substrate traversing unit having at least one positioning axis situated almost parallel to the plane formed by the substrate and regulatable in particular for traversing the substrate in the xy plane. With the help of the substrate traversing unit, the substrate may be traversed, e.g., orthogonally to the direction of transport. It is advantageously possible through the interaction of the substrate traversing unit and the conveyance device to position the substrate freely in the xy plane.

In a preferred variant of the present invention, the substrate traversing unit has two positioning axes situated almost perpendicular to one another and largely parallel to the plane formed by the substrate and are regulatable in particular. With the help of this measure, it is possible for substrate positioning to be implemented along both positioning axes, if necessary, in particular parallel to the substrate plane without additional traversing and/or positioning of the substrate with the conveyance device.

The optical traversing unit advantageously has at least two positioning axes situated almost perpendicular to one another and largely parallel to the plane formed by the substrate and are regulatable in particular. The position measuring unit may be displaced back and forth along these two positioning axes accordingly, so that it may be displaced flexibly at least over the entire area of the substrate. For example, with the help of the optical device, a plurality of different assembly sites on a substrate may be approached without having to displace the substrate itself much, relatively speaking.

In an advantageous embodiment of the present invention, the optical traversing unit has a focusing axis, in particular one that is regulatable and situated almost perpendicular to the plane formed by the substrate for focusing the first and/or second location, in particular the particular assembly site on the substrate. This makes it possible for components to be situated and/or assembled on different levels of the substrate, for example, and/or for multiple components to be situated one above the other.

In a special refinement of the present invention, at least one precision positioning unit having two positioning axes is provided, in particular positioning axes that are regulatable and situated almost perpendicular to one another and largely parallel to the plane formed by the substrate for precision positioning of one or both actual positions and/or the substrate and/or the component. With the help of this measure, it is possible for the first traversing unit for the feeding movement of the component and/or the substrate traversing unit to preposition the component and/or the substrate relatively approximately, i.e., with a comparatively low precision, in the field of vision of the optical device, so that these traversing units may be implemented relatively inexpensively. The position deviation of the component relative to the substrate determined with the help of the position measuring unit is then compensated by the much more accurate precision positioning drive of the precision positioning unit.

In an advantageous variant of the present invention, a maximum range of the precision positioning unit is multiple times smaller than a maximum traversing range of the first traversing unit. This measure yields a further increase in assembly precision and rate, because the traversing range may be controlled and/or regulated with a high precision, in particular because of the comparatively small traversing range of the precision positioning unit. The much smaller traversing range of the precision positioning drive is implemented, for example, in the range of a few hundred micrometers. Due to this small traversing range, the precision positioning drive may also be implemented very inexpensively even with a high precision. In addition, only very low masses need be accelerated by the precision positioning drive, so that in high precision assembly operations in particular, this permits a much more rapid alignment and/or adjustment of the components to be joined relative to one another via the precision positioning drive in comparison with that achieved via the axes of the other traversing units.

The traversing of the precision positioning unit is preferably accomplished by piezoelectric, electromagnetic, and/or electrodynamic drives.

The substrate traversing unit is advantageously designed as a precision positioning unit. In this way, the substrate is manipulated with respect to its position relative to the component, preferably by the precision positioning drive, i.e., in this variant the precision positioning drive is integrated into the conveyance device rather than the assembly head. Therefore, in an advantageous manner, the mass of the assembly head to be moved may be kept relatively low to implement approximate, highly dynamic traversing movements to feed the component to the assembly site via the corresponding assembly axes.

In a special refinement of the present invention, at least the first traversing unit, the optical traversing unit, and the substrate traversing unit are each situated on a stationary base unit of the device for mutually independent traversing of the traversing units. With the help of this measure, for example, the position measuring device may be positioned over the assembly position on the substrate neutrally with regard to time, especially by the optical traversing unit. In other words, the position measuring unit may already be positioned over the substrate, for example, while the component holder and/or gripper or assembly head picks up the component from a loading device at the first location and moves it to the second location, i.e., the assembly site on the substrate.

The first traversing unit positions, e.g., the component held on the component holder, preferably via the pre-positioned position measuring unit and/or optical device, in which case the latter has, if necessary, already determined the actual position of the substrate and analyzed it accordingly. Then, i.e., partially and also simultaneously, the actual position of the component is also determined and analyzed accordingly, so that the position deviation of the component relative to the joining position and/or assembly position on the substrate is determined and is corrected, i.e., compensated via the positioning axes of the corresponding traversing units, in particular by the positioning unit.

In general, in position recognition, both the component and the substrate are situated in the field of vision of the position measuring unit, so that the position correction may be performed in a closed control circuit between image processing and the regulatable positioning axes. In an advantageous manner, this control circuit detects the misalignment of the component relative to the substrate again after each position correction and thus makes it possible to repeat the adjustment procedure through the positioning axes of the traversing units, preferably by the precision positioning unit, especially when an allowed assembly tolerance is exceeded.

Only after the required, i.e., defined adjustment precision has been achieved is the position measuring unit and/or the optical device withdrawn from the joining axis, i.e., the area between the component and the substrate, and only then is the component deposited precisely in position on the substrate by using a joining axis, i.e., a z axis of the first traversing unit and/or the gripper, this z axis being almost perpendicular to the plane formed by the substrate.

In a special variant of the present invention, the conveyance device has a lifting unit which is adjustable almost perpendicular to the plane formed by the substrate for lifting and securing a substrate carrier. The lifting unit here preferably includes at least the substrate traversing unit, in particular the precision positioning unit. With this lifting unit, the substrate carrier is generally lifted from the conveyor belt upward by a few millimeters, for example, and then may be moved in the xy plane for correction of the actual position of the substrate by the integrated precision positioning unit.

In general, two substrate traversing units may be provided, for example, in which case one of the two traversing units is designed as a precision positioning unit for precision positioning in particular. Accordingly, the first substrate traversing unit may, for example, traverse the substrate comparatively imprecisely and especially then the precision positioning unit may position the substrate comparatively accurately, i.e., precisely.

### BRIEF DESCRIPTION OF THE DRAWINGS

FIG. 1 shows a schematic detail of a device according to the present invention.

FIG. 2 shows a schematic detail of another device according to the present invention.

### DETAILED DESCRIPTION

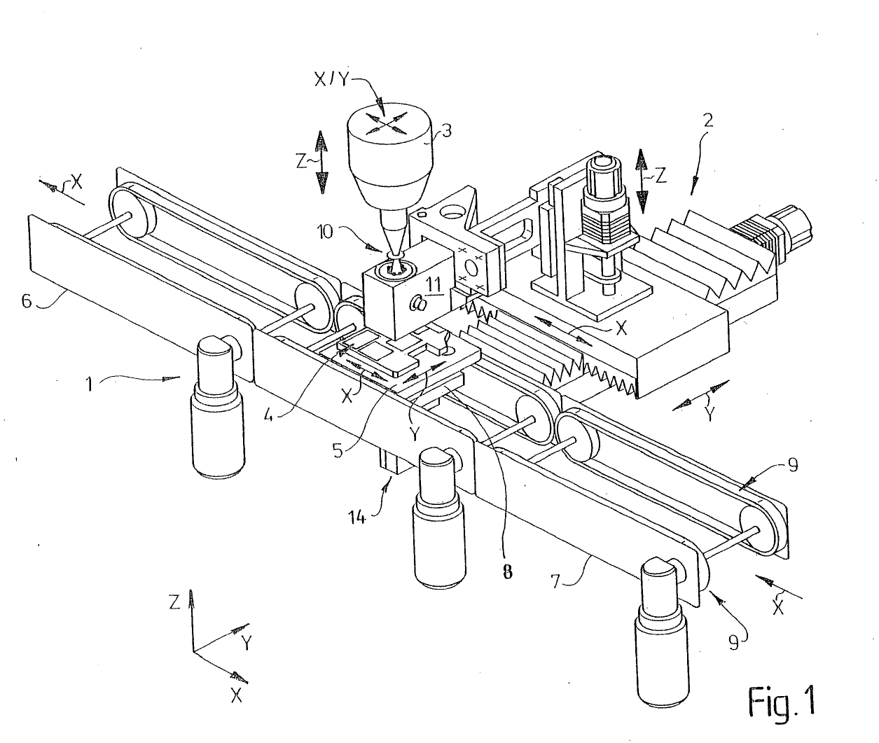

FIG. 1 shows a transfer belt 1, an optical module 2, and an assembly head 3 of a device according to the present invention. Optical module 2 includes essentially an optical positioning unit and an optical head 11. With the help of transfer belt 1, a substrate 4 which is situated individually or in a multiple usage on a workpiece carrier 5, is moved continuously toward and away from the device according to the present invention. Transfer belt 1 includes an output buffer segment 6 and an input buffer segment 7 with which line interlinking of the device according to the present invention is made possible in an advantageous manner to yield a microtechnical manufacturing system composed of multiple manufacturing devices. It is only through this interlinking capability that economically advantageous mass production of corresponding semiconductor products is ensured at a comparatively high throughput of approximately 900 components per hour.

For precision positioning of substrate 4, transfer belt 1 includes a micromanipulator 8, the drive (not shown in greater detail here), e.g., via a piezoelectric drive permitting traversing of substrate 4 along two axes X, Y. For example, a maximum traversing distance of micromanipulator 8 amounts to approx. 200 micrometers in x and y directions. Because of the relatively small working range of micromanipulator 8, an extremely high precision is feasible at a relatively low economic cost. A corresponding micromanipulator 8 also has much smaller masses to be accelerated than the axes of a traversing unit positioning assembly head 3, so a relatively short adjustment time in precision positioning of chip 10 relative to substrate 4 is feasible. Thus, comparatively demanding assembly operations such as flip-chip assembly may be implemented relatively favorably economically with a relatively high precision, in particular better than 5 μm, and short cycle times, preferably less than 4 seconds.

Micromanipulator 8 is part of an indexer 14 which raises substrate 4 and/or workpiece carrier 5 a few millimeters in direction z above conveyor belt 9 in a relatively simple manner and at the same time securely fixes it by conical centering mandrels, for example. This yields a relatively stable position of the assembly site for a component 10.

Component 10 is positioned by assembly head 3 over substrate 4 using a traversing unit (not shown in greater detail here). The traversing unit together with assembly head 3 makes it possible to pick up component 10 at any location in the relatively large working space, i.e., traversing range of the traversing unit, and permits a relatively quick and approximate positioning of component 10 over substrate 4. A corresponding traversing unit may pick up any components 10 at any locations within the working space very flexibly at a comparatively favorable economic cost and position them on the substrate.

In general, optical head 11 may traverse the entire substrate 4 and/or a multiple usage [device] via the optical traversing unit of optical module 2.

Especially while component 10 is being picked up and/or moved to the position illustrated in FIG. 1, optical head 11 may be positioned over substrate 4 via corresponding axes of optical module 2, and substrate 4 may be securely fixed in position by lifting workpiece carrier 5. If necessary, the actual position of substrate 4 is determined during the movement of component 10 by assembly head 3 and/or its traversing unit, and after positioning component 10 over substrate 4 and/or over optical head 11 of optical module 2, the actual position of the component is determined precisely.

Then an analyzer unit (not shown in greater detail) calculates the actual position of component 10 by using the actual position of substrate 4 and/or the joining site on substrate 4, and in the event the deviation between the two actual positions is too great, this deviation is mostly compensated by micromanipulator 8. Both component 10 and the assembly site on substrate 4 are constantly within the field of vision of optical head 11, so that the position correction and/or adjustment may be made in a closed control circuit between image processing and axes X, Y, and/or an axis of rotation theta of micromanipulator 8. The axis of rotation theta is parallel to the z axis.

After each position correction, this control circuit again determines the position deviation of the two actual positions relative to one another, and when the allowed assembly tolerances are exceeded, it initiates a repetition of the adjustment procedure using axes X, Y, and theta of micromanipulator 8. Only after achieving the required adjustment precision is optical head 11 retracted laterally out of the joining area (Y axis of optical module 2) and component 10 is set down at the defined location on substrate 4 along axis Z of assembly head 3, i.e., it is joined there.

The traversing unit of assembly head 3 may be, for example, part of an automatic assembly system. Such automatic assembly systems are known, for example, as pick-and-place systems or as die bonders.

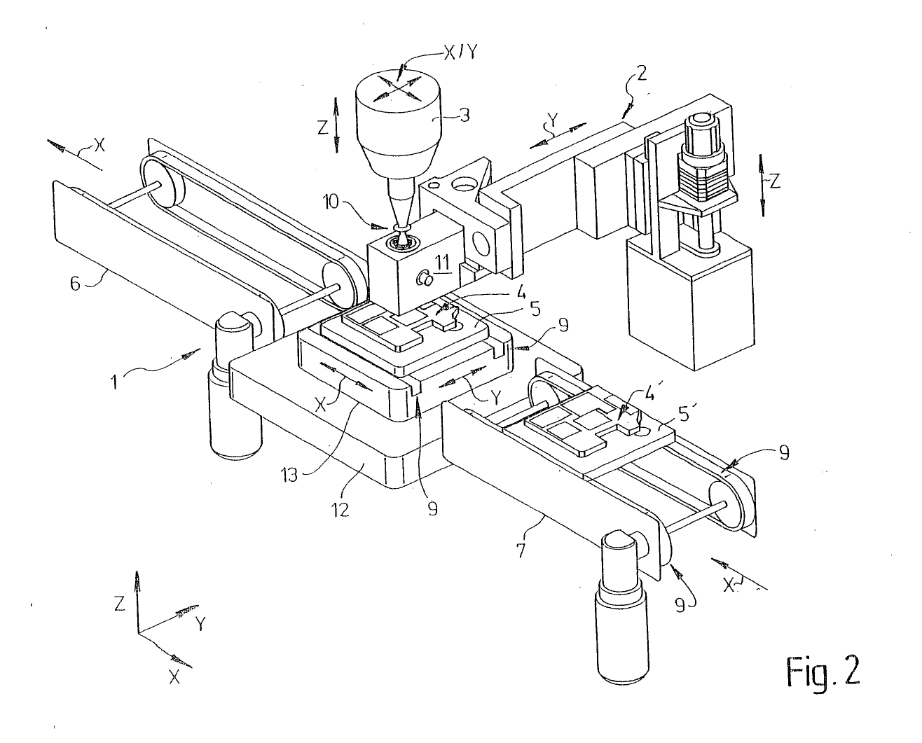

FIG. 2 shows another device according to the present invention, where similar, i.e., comparable elements are labeled with the corresponding reference notation according to FIG. 1.

In contrast with the device according to FIG. 1, the device according to FIG. 2 has a stator 12 on which a rotor 13 is situated. In a manner not shown in detail here, rotor 13 may also include a micromanipulator 8 having a comparatively small working range for precision positioning of substrate 4 and/or workpiece carrier 5.

For assembly of component 10 on substrate 4, rotor 13 moves toward input buffer segment 7, so that it picks up a workpiece carrier 5′ having a substrate 4′ and moves it to the position illustrated in FIG. 2. In this position, the actual position of substrate 4 and/or the assembly site as well as the actual position of component 10 are determined relative to one another by optical head 11 and traversed along the X and/or Y axes according to the measurement and/or control procedures executed previously until achieving the required adjustment precision.

The particular assembly position on substrate 4 may always in the same area beneath optical head 11, even when there are multiple assembly sites on one substrate 4, via stator 12 and/or rotor 13. In this way, optical head 11 may be moved merely by using a relatively simple monoaxial lifting drive of optical module 2, e.g., a pneumatic cylinder or the like, along axis Y in the joining area of component 10 and/or the assembly site and to a resting position (not shown in greater detail) outside the area of substrate 4. In other words, different assembly positions on substrate 4 may be reached by the fact that rotor 13 is positioned relative to optical head 11, which is stationary with regard to its measurement position.

Approaching the assembly positions as well as the position correction after the measurement may be performed on rotor 13 by the same drive, i.e., by rotor 13 or by a separate micromanipulator 8 according to FIG. 1.

Essentially, it is only through the combination of features according to the present invention that it is possible to have an assembly device operating at a high throughput with a high flexibility and precision, where the directed flow of material, i.e., the conveyance of substrates 4 on conveyor belt 1 through the device according to the present invention, makes it possible to interlink them in an automated production line for serial production of semiconductor products.

List of Reference Notation:

| | |
|---|---|
| 1 | transfer belt |
| 2 | optical module |
| 3 | assembly head |
| 4 | substrate |
| 5 | workpiece carrier |
| 6 | output buffer segment |
| 7 | input buffer segment |
| 8 | micromanipulator |
| 9 | belt |
| 10 | component |
| 11 | optical head |
| 12 | stator |
| 13 | rotor |
| 14 | indexer |
| X | axis |
| Y | axis |
| Z | axis |

What is claimed is:

1. A device for assembly of components (10), in particular semiconductor chips (10), on a substrate (4) having a first traversing unit for picking up the component (10) together with a component holder (3) at a first location and setting down the component (10) at a second location on the substrate (4), a position measuring unit (2, 11) for optically determining an actual position of the component (10) as a function of an actual position of the substrate (4) being situated on an optical traversing unit (2) for traversing the position measuring unit (2, 11) from a working position in the area of the substrate (4) to a resting position,
wherein the substrate (4) is situated on a conveyance device (1, 6, 7) for largely continuous supply and removal of numerous substrates (4) to and from the device.

2. The device as recited in claim 1,
wherein the position measuring unit (2, 11) includes at least one optical device (11) having two opposite directions of measurement for determining the two actual positions.

3. The device as recited in one of the preceding claims,
wherein the conveyance device (1, 6, 7) includes at least one substrate traversing unit (1, 8, 13) having at least one positioning axis (X, Y) situated almost parallel to the plane formed by the substrate (4) for traversing the substrate (4) in the direction of the positioning axis (X, Y).

4. The device as recited in one of the preceding claims,
wherein the substrate traversing unit (1, 8, 13) has two positioning axes (X, Y) situated almost perpendicular to one another and largely parallel to the plane formed by the substrate (4).

5. The device as recited in one of the preceding claims,
wherein the optical traversing unit (2) has at least two positioning axes (X, Y) situated almost perpendicular to one another and largely parallel to the plane formed by the substrate (4).

6. The device as recited in one of the preceding claims,
wherein the optical traversing unit (2) has a focusing axis (Z), situated almost perpendicular to the plane formed by the substrate (4), for focusing the first and/or second location.

7. The device as recited in one of the preceding claims,
wherein at least one precision positioning unit (8) having two positioning axes (X, Y) almost perpendicular to one another and largely parallel to the plane formed by the substrate (4) is provided for precision positioning of one or both actual positions.

8. The device as recited in one of the preceding claims,
wherein a maximum traversing range of the precision positioning unit (8) is multiple times smaller than a maximum traversing range of the first traversing unit.

9. The device as recited in one of the preceding claims,
wherein the substrate traversing unit (1, 8, 13) is designed as a precision positioning unit (8).

10. The device as recited in one of the preceding claims,
wherein the first traversing unit, the optical traversing unit (2) and the substrate traversing unit (1, 8, 13) are each situated on a stationary base unit of the device for mutually independent traversing of the traversing units (1, 2, 8, 13).

11. The device as recited in one of the preceding claims,
wherein the conveyance device (1, 6, 7) has a lifting unit, which is adjustable almost perpendicular to the plane formed by the substrate (4), for lifting and securing a substrate carrier (5).

12. The device as recited in one of the preceding claims,
wherein at least the lifting unit includes the precision positioning unit (8).

13. A method of assembly of components (10), in particular semiconductor chips (10), on a substrate (4) having a first traversing unit for picking up the component (10) together with a component holder (3) at a first location and setting down the component (10) at a second location on the substrate (4), an optical position measuring unit (2, 11) for determining an actual position of the component (10) as a function of an actual position of the substrate (4) being situated on an optical traversing unit (2) for traversing the position measuring unit (2, 11) from a resting position to a working position in the area of the substrate (4),
wherein a device as recited in one of the preceding claims is used.
